(19) United States
(12) Patent Application Publication
(10) Pub. No.: US 2011/0290087 A1
(43) Pub. Date: Dec. 1, 2011

(54) HEXAGONAL WRENCH AUXILIARY DEVICE

(76) Inventor: Kun-Chen Chen, Dajia Chen (TW)

(21) Appl. No.: 12/787,487

(22) Filed: May 26, 2010

(51) Int. Cl. B25B 23/00

(52) U.S. Cl. 81/180.1

(57) ABSTRACT

The hexagonal wrench auxiliary device has a body. The body has two ends, a first end surface and a second end surface. The first end surface and the second end surface are respectively defined in the ends of the body. The first end surface has a center and multiple mounting holes. The multiple mounting holes are respectively formed in the center and around the center on the first end surface and shaped in different sizes to correspond to and be mounted around one of the hexagonal wrenches. The second end surface has a connecting stem mounted on and protruding from the second end surface. The connecting stem may be held to push the hexagonal wrench and rotate the hexagonal head fastener. The body enlarges a moment arm of the wrench and provides a labor saving and easy holding effect.

### BACKGROUND OF THE INVENTION

1. Field of the Invention

The present invention relates to a hexagonal wrench auxiliary device for a hexagonal wrench to extend a length of the hexagonal wrench and to provide easy-hold and labor saving effect.

2. Description of Related Art

With reference to FIG. 4, a convention hexagonal wrench assembly has multiple hexagonal wrenches (40) of different sizes. Each hexagonal wrench (40) is L-shaped, and has a first stem (41) and a second stem (42). The first stem (41) is longer than the second stem (42). The first stem (41) and the second stem (42) respectively have hexagonal heads to correspond to and screw a hexagonal head fastener.

When the conventional hexagonal wrench (40) is in use, the hexagonal head on the second stem (42) is inserted into the hexagonal head fastener, the first stem (41) is pushed to turn the wrench (40) and to fasten or loosen the hexagonal head fastener. Because the first stem (41) is longer than the second stem (42), turning the wrench (40) with pushing the first stem (41) provides a larger moment to facilitate tightening and loosening of fasteners.

If a hexagonal fastener is positioned deep inside a machine, the hexagonal head of the first stem (41) is inserted in the hexagonal head fastener to fasten or loosen the hexagon socket cap head screw.

However, the second stem (42) is shorter than the first stem (41) and provides a smaller moment. The second stem (42) is not easily held and requires more force to fasten or loosen the hexagonal head fastener.

To overcome the shortcomings, the present invention tends to provide a hexagonal wrench auxiliary device to mitigate or obviate the aforementioned problems.

### SUMMARY OF THE INVENTION

The main objective of the present invention is to provide a hexagonal wrench auxiliary device for a hexagonal wrench to extend a length of the hexagonal wrench and to provide easy-hold and labor saving effect.

The hexagonal wrench auxiliary device has a body. The body has two ends, a first end surface and a second end surface. The first end surface and the second end surface are respectively defined in the ends of the body. The first end surface has a center and multiple mounting holes. The multiple mounting holes are respectively formed in and around the center on the first end surface and shaped in different sizes to correspond to and be mounted around one of the hexagonal wrenches. The second end surface has a connecting stem mounted on and protruding from the second end surface. The connecting stem may be held to push the hexagonal wrench and rotate the hexagonal head fastener. The body enlarges a moment of the wrench and provides labor saving and easy holding effect.

Other objects, advantages and novel features of the invention will become more apparent from the following detailed description when taken in junction with the accompanying drawings.

### BRIEF DESCRIPTION OF THE DRAWINGS

FIG. 1 is a perspective view of a hexagonal wrench auxiliary device in accordance with the present invention;

FIG. 2 is an exploded perspective view of the hexagonal wrench auxiliary device in FIG. 1 with a hexagonal wrench;

FIG. 3 is an operational side view in partial section of the hexagonal wrench auxiliary device with a hexagonal wrench in FIG. 2 connected to a handle; and

FIG. 4 is a perspective view of a convention hexagonal wrench assembly.

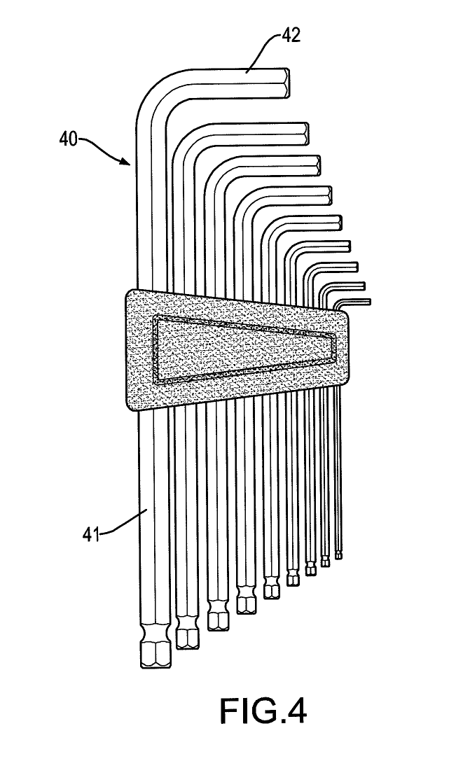

### DETAILED DESCRIPTION OF PREFERRED EMBODIMENT

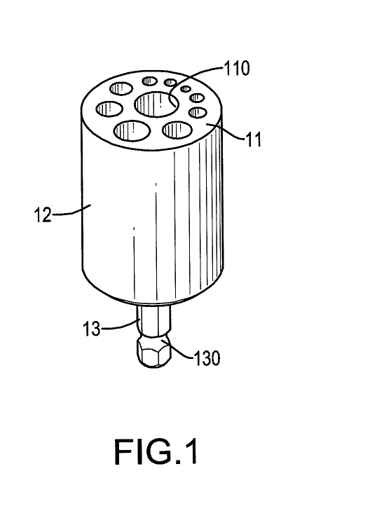

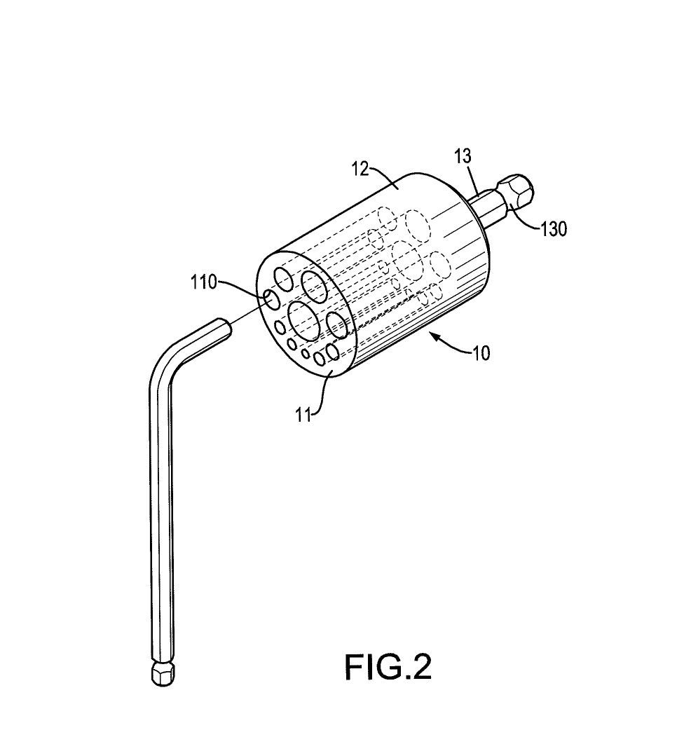

With reference to FIGS. 1, 2 and 3, a hexagonal wrench auxiliary device in accordance with the present invention is used with a hexagonal wrench (40) to fasten or loosen a screw. The hexagonal wrench (40) is L-shaped and has a first stem (41) and a second stem (42). The first stem (41) is longer than the second stem (42). The first stem (41) and the second stem (42) are respectively have hexagonal heads.

The hexagonal wrench auxiliary device has a body (10) and a handle (20). The body (10) is cylindrical, has two ends, a first end surface (11), a second end surface (12) and a connecting stem (13). The first end surface (11) and the second end surface (12) are respectively defined in the two ends of the body (10). The first end surface (11) has a center and multiple mounting holes (110). The mounting holes (110) are respectively formed in the center and around the center of the first end surface (11), and are shaped different sizes to correspond to and mount around the hexagonal wrenches (40) of different sizes. The mounting holes (110) may be shaped circular, hexagonal or other geometric shapes.

The connecting stem (13) is mounted on and protrudes from the second end surface (12) to prolong the length of the hexagonal wrench auxiliary device, and may be used as a handle bar to provide an easy holding effect. The connecting stem (13) may have a hexagonal cross section and an engaging recess (130). The engaging recess (130) is formed in and around the connecting stem (13).

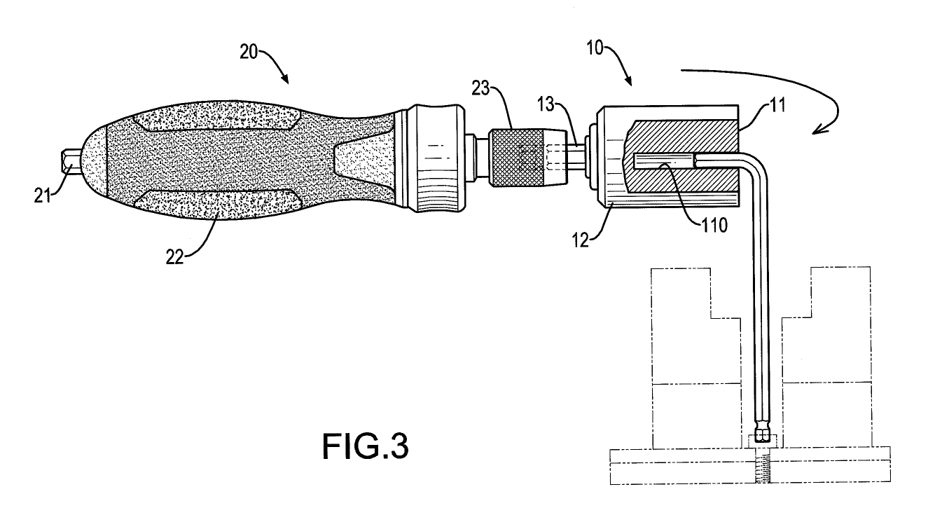

With reference to FIG. 3, the handle (20) is detachably connected to the body (10), has a shaft (21), a grip (22) and a connecting assembly (23). The shaft (21) is mounted through the handle (20) and has a front end and a rear end. The grip (22) is mounted around the shaft (21) between the front end and the rear end of the shaft (21). The connecting assembly (23) is mounted on the front end of the shaft (21) and is detachably connected to and engages the engaging recess (130) of the connecting stem (13). When the screw is positioned at a deep position inside a machine, the hexagonal head on the first stem (41) of the hexagonal wrench (40) is inserted into the screw and inserted into the deep position inside the machine. The mounting holes (110) of the body (10) are mounted around the second stem (42) of the hexagonal wrench (40). The connecting stem (13) of the body (10) is pushed to turn the hexagonal wrench (40) and to fasten or loosen the screw. Because the body (10) prolongs a moment of the wrench (40), labor saving and easy holding effect is provided.

Furthermore, the body (10) also may be connected to the handle (20) to further extend the moment by the shaft (21) and further provide labor-saving and comfortable holding effects. The connecting assembly (23) of the handle (20) is connected to and engages the engaging recess (130) of the body (10). The handle (20) is connected on the body (10) and helps the user to fasten or loosen the screw easily.

Even though numerous characteristics and advantages of the present invention have been set forth in the foregoing description, together with details of the structure and function of the invention, the disclosure is illustrative only. Changes may be made in detail, especially in matters of shape, size and arrangement of parts within the principles of the invention to the full extent indicated by the broad general meaning of the terms in which the appended claims are expressed.

What is claimed is:

1. A hexagonal wrench auxiliary device comprising:
a body having
two ends;
a first end surface defined in one of the ends of the body and having
a center; and
multiple mounting holes respectively formed in the center and around the center on the first end surface and shaped different sizes; and
a second end surface defined in the other ends of the body and having a connecting stem mounted on and protruding from the second end surface.

2. The hexagonal wrench auxiliary device as claimed in claim 1, wherein the mounting holes are circular.

3. The hexagonal wrench auxiliary device as claimed in claim 2, wherein the body is cylindrical.

4. The hexagonal wrench auxiliary device as claimed in claim 3 further having a handle detachably connected to the body.

5. The hexagonal wrench auxiliary device as claimed in claim 4, wherein
the connecting stem further has an engaging recess formed in and around the connecting stem; and
the handle further has
a shaft mounted through the handle and having a front end and a rear end;
a grip mounted around the shaft between the front end and the rear end of the shaft; and
a connecting assembly mounted on the front end of the shaft and detachably connected to the connecting stem.

6. The hexagonal wrench auxiliary device as claimed in claim 1, wherein the body is cylindrical.

7. The hexagonal wrench auxiliary device as claimed in claim 1 further having a handle detachably connected to the body.

8. The hexagonal wrench auxiliary device as claimed in claim 7, wherein
the connecting stem further has an engaging recess formed in and around the connecting stem; and
the handle further has
a shaft mounted through the handle and having a front end and a rear end;
a grip mounted around the shaft between the front end and the rear end of the shaft; and
a connecting assembly mounted on the front end of the shaft and detachably connected to the connecting stem.
